(19) United States
(12) Patent Application Publication
(10) Pub. No.: US 2017/0016105 A1
(43) Pub. Date: Jan. 19, 2017

(54) Method for Coating a Substrate, in Which a Wire-Like Spray Material is Melted in an Electric Arc and is Isolated as a Layer on the Substrate and Electric Arc Wire Sprayed Layer

(71) Applicant: Daimler AG, Stuttgart (DE)

(72) Inventors: Rainer ALBAT, Wienstadt (DE); Thomas BEHR, Elchinge (DE); Jens BOEHM, Neuhausen (DE); Tilmann HAUG, Weissenhorn (DE); Volker LAGEMANN, Ulm (DE); Manuel MICHEL, Neuhausen a.d.F. (DE); Tobias SCHAEDEL, Remshalden-Grunbach (DE); Martin STROEER, Immenstaad (DE)

(73) Assignee: Daimler AG, Stuttgart (DE)

(21) Appl. No.: 15/124,571

(22) PCT Filed: Feb. 6, 2015
(86) PCT No.: PCT/EP2015/000252

§ 371 Date: Sep. 8, 2016

(30) Foreign Application Priority Data
Mar. 11, 2014 (DE) 10 2014 003 114.4

(51) Int. Cl. C23C 4/06; C23C 4/02; C23C 4/18; C22C 38/02; B32B 15/20; C22C 38/04; C22C 38/00; B32B 15/01; B32B 15/18; C23C 4/131; C22C 38/20

(52) U.S. Cl. CPC C23C 4/06; C23C 4/131; C23C 4/02; C23C 4/18; C22C 38/02; C22C 38/20; C22C 38/04; C22C 38/001; B32B 15/012; B32B 15/18; B32B 15/20; B32B 2307/554

(57) ABSTRACT

A method for coating a substrate in which a wire-like spray material based on iron is melted in an electric arc and is isolated as a layer on the substrate is disclosed. The following alloy components are contained in the spray material: carbon: 0.1% by weight to 0.3% by weight; manganese: 1.5% by weight to 2.0% by weight; and silicon: 0.25% by weight to 0.4% by weight, respectively with regard to a total weight. The substrate is an aluminium alloy and the surface thereof is roughened mechanically before the coating in such a way that a roughness is formed with undercuts which are filled with the spray material over the course of the coating and therefore a cause a mechanical interlocking of the coating with the substrate. The coating is removed on the surface. An electric arc wire sprayed layer based on iron on the substrate is also disclosed.

### BACKGROUND AND SUMMARY OF THE INVENTION

The invention relates to a method for coating a substrate in which a wire-like spray material is melted in an electric arc and is isolated as a layer on the substrate, as well as an electric arc wire sprayed layer on a substrate.

During the production of combustion engines, as low as possible friction and high resistance to abrasion and wear are sought for reasons of energy efficiency and reduction of emissions. For this purpose, engine components such as, for example, cylinder bores or the walls thereof are provided with a running surface layer or liners are inserted into the cylinder bores which are provided with a running surface layer. The application of such running surface layers occurs mostly by means of thermal spraying, for example electric arc wire spraying. During electric arc wire spraying, an electric arc is generated between two wire-like spray materials by creating a voltage. Here, the wire sprays melt and are, for example, transported by means of an atomizing gas to the surface to be coated, for example the cylinder wall, where they accumulate.

A wire-like spray material for electric arc wire spraying is know from DE 102009061274 B3, comprising substantially iron, which is distinguished in that the spray material is formed at least with carbon as a microalloy in such a way that bainite and martensite arise during solidification of the spray material. Among other things, 0.1% by weight to 0.28% by weight carbon, 1.4% by weight to 2.1% by weight manganese and 0.05% by weight to 0.3% by weight silicon are contained in the spray material.

It is an object of the invention to specify an improved method for electric arc wire spraying with which a coating having good adhesion, strength, workability and thermal conductivity can be produced.

It is a further object of the invention to specify an improved spray material which is applied to a substrate by electric arc wire spraying and is easily workable and which has good adhesion, strength and thermal conductivity.

The object is solved according to the invention by a method for electric arc wire spraying and an electric arc wire sprayed layer.

The use of an aluminum alloy as a substrate to which the coating is applied can be particularly advantageous for the application of the method according to the invention or the layer according to the invention during the production of cylinder crankcases of combustion engines, since therefore on the one hand considerably lighter combustion engines can be produced in comparison to previously used cast iron engines, and on the other hand aluminum alloys have better thermal conductivity. The latter allows a quicker discharge of combustion heat, whereby the risk of oil coking can be clearly reduced. However, the tribological loading ability of aluminum alloys is clearly lower than the iron or steel alloys usually used in engine construction. Therefore, until now, grey cast iron liners have usually been inserted or poured into aluminum crankcases in order to ensure a sufficient tribological loading ability. These liners have a wall thickness of at least a few millimeters in which a clearly lower thermal conductivity is present, and do not achieve complete connection to the aluminum substrate, whereby the heat transfer is impaired. The advantage of the aluminum alloy is thereby predominantly cancelled out with regard to improved heat dissipation.

In petrol engines which have comparably low thermal loading, the poured-in liners have therefore also been replaced by wear protection layers in the form of thermal spray layers. These have a similar tribological loading ability to the liners, but have wall thicknesses which range from 10 μm to several 100 μm, and they have a substantially better connection to the substrate. Due to such a layer, the dissipation of the combustion heat towards the aluminum substrate with good thermal conductivity can occur without great impairment.

In the case of significantly more heavily loaded, charged diesel engines, the requirements for wear protection layers and the production methods thereof are substantially higher. On the one hand, more heat must be dissipated, due to which a layer which is as thin as possible is sought. On the other hand, the layer must withstand the friction and impact loading by the pistons and may in particular not chip away from the substrate. The latter can be achieved by a suitable roughening of the substrate, which causes a good mechanical interlocking between the wear protection layer and the substrate as a priority by means of introduced undercuts which are filled by the spray material. Here, however, a suitable ratio between the total height of the roughening profile and the total thickness of the spray layer must be noted in order to achieve the necessary quick and even heat dissipation into the substrate. It has advantageously been shown that an averaged roughness depth Rz ranging from 10 μm to 150 μm and a layer thickness of 30 μm to 150 μm represent a suitable parameter combination, which on the one hand enable a sufficient interlocking and on the other hand a sufficiently quick and even heat dissipation with sufficient tribological loading ability. Here, the roughness depth is defined as the sum of the height of the largest profile peak and the depth of the largest profile valley within an individual measured stretch. The averaged roughness depth Rz results from averaging the results of 5 individual measured stretches. The layer thickness is determined from a reference line along the largest profile peaks of the surface profile of the substrate up to the surface of the spray layer. For the majority of application cases, a maximum averaged roughness Rz of up to 100 μm is sufficient, for many even only 50 μm. The method according to the invention and the layer according to the invention increase the thermal conductivity in the region of the cylinder wall substituted by the coated aluminum alloy compared to a poured-in grey cast iron liner by a factor of 4.

### DETAILED DESCRIPTION OF THE INVENTION

In the method according to the invention for producing the layer according to the invention, a wire-like spray material is used for electric arc wire spraying which substantially comprises iron, i.e., the material consists of, besides the explicitly referred to alloy components and unavoidable impurities, an iron residue which forms the largest component of the alloy.

The spray material is preferably formed having carbon as a microalloy in such a way that at least pearlite, bainite and lower proportions of martensite already arise during solidification of the spray material, wherein, additionally, microalloy elements can be provided for the formation of wear-resistant phases as well as for improving the tribological properties. A wear protection layer having a comparably low hardness ranging from 250 to 400 HV 0.1 can thereby be generated and applied. Such a layer represents a suitable compromise between workability of the layer and the required tribological properties thereof. The latter have, as a priority, a lower degree of wear of the nanocrystalline structure at simultaneously lower hardness. The low hardness is, in particular, advantageous with regard to impact loading such as, for example, a cylinder running track experiences by a piston. Harder layers crack more easily (egg shell effect).

The microalloys referred to above are those alloys which are formed predominantly from one component to which only low quantities of further components are added in relation to a total mass. Finely striped pearlite, consisting of hard Fe3C as well as ferrite, is a tribologically positively active phase. Bainite is a transformation phase of average hardness and wear resistance. Martensite is a hard, wear-resistant structure. The formation of martensite, in particular the proportion of and the distribution in the overall structure, can be targetedly influenced by the type of cooling of the spray material and by the selection of the alloy components of the microalloy. A layer generated during an accumulation of a layer generated by means of electric arc wire spraying using the spray material referred to on an aluminum substrate, for example a cylinder running surface, preferably comprises bainite, wear-resistant islands of martensite as well as finely striped pearlite.

These preferred properties can in particular be achieved if the following further alloy components are present in the spray wire:
copper 0.05% by weight to 0.25% by weight and/or
chromium 0.001% by weight to 0.1% by weight and/or
titanium 0.001% by weight to 0.01% by weight and/or
phosphorus 0.001% by weight to 0.02% by weight and/or
sulphur 0.001% by weight to 0.02% by weight and/or
vanadium 0.0001% by weight to 0.001% by weight and/or
aluminum 0.001% by weight to 0.02% by weight and/or
boron 0.0001% by weight to 0.0004% by weight and/or
nitrogen 100 ppm to 200 ppm.

The quantity specifications are in percent by weight respectively with regard to a total weight, if no other specifications are made.

In a particularly advantageous embodiment of the method and layer, the aluminum substrate has, as least in sections, a thickness ranging from 2 to 8 mm. This allows, for example, the production of a cylinder crankcase firstly having sufficient hardness and secondly having a very quick dissipation of combustion heat to a water jacket which is located on the non-coated side of the aluminum substrate designed as a cylinder running track.

Particularly advantageously, the method according to the invention and the layer according to the invention are used for the production of diesel engines having a cylinder crankcase made from an aluminum alloy having a thermally coated cylinder running track, and with steel pistons. Due to the different thermal conductivities of steel and aluminum, such a combination has, until now, only been possible with considerable construction and regulatory technical effort in which, for example, firstly a poured-in steel liner in the cylinder running track and secondly an active cooling of the piston with oil spraying over the entire operating duration were necessary. As a consequence thereof, this solution was also unfavorable in terms of energy in the prior art. However, with the use of the method according to the invention and the layer according to the invention, a highly loadable diesel engine having high power density can be produced which has steel pistons and a crankcase made from an aluminum alloy having a thermally coated running track, without leading to the known coking and to the associated damages of oil, pistons and running path during operation. The advantages of use of the combination of steel piston and aluminum crankcase can thereby be made use of completely, and contrary effects such as a constantly active cooling via oil spray nozzles which is unfavorable in terms of energy or similar measures can be prevented or at least limited.

Below, the invention is explained in more detail by means of two exemplary embodiments:

According to a first exemplary embodiment, firstly the surface of a substrate to be coated made from an aluminum alloy is mechanically roughened in such a way that an averaged roughness depth RZ of approximately 20 μm is formed with undercuts. Then the roughened region of the substrate is coated by means of electric arc wire spraying, wherein a wire-like spray material based on iron is used, which contains the following as further alloy components:
carbon 0.12% by weight
silicon 0.28% by weight
manganese 1.7% by weight
copper 0.18% by weight
chromium 0.027% by weight
nitrogen 150 ppm.

The quantity specifications are in percent by weight with regard to a total weight respectively.

In the course of the coating with the spray material, the valleys and in particular also the undercuts of the roughened substrate surface are filled with the spray material and therefore cause a mechanical interlocking of the coating with the substrate. Then, the coated surface is smoothed by honing and is thereby removed up to a remaining thickness of approximately 100 μm.

According to a second exemplary embodiment, the running track of a cylinder crankcase made from an aluminum alloy is used in a diesel engine and, in accordance with the first exemplary embodiment, is coated with a wear protection layer. The crankcase has a wall thickness of approximately 5 mm between the wear protection layer and a water jacket located behind this. Steel pistons are arranged moveably in the crankcase.

The combustion heat occurring during operation of the diesel engine is dissipated sufficiently quickly by the wear protection layer and the wall of the crankcase lying behind this to the water located in the water jacked, even with high loading of the engine, in order to clearly reduce the risk of oil coking and therefore also of damage to the piston and/or the running track without the permanent use of active oil cooling. At the same time, the wear protection layer is sufficiently thick and soft and is also connected to the running track wall sufficiently firmly by the mechanical interlocking in order to be able to permanently withstand the operational loading, in particular the transverse forces of the steel piston.

The method according to the invention and the layer according to the invention are therefore particularly suitable for the production of high-loaded diesel engines due to their excellent tribological properties.

1.-6. (canceled)

7. A method for coating a substrate, comprising the steps of:
melting a wire-like spray material based on iron in an electric arc and coating the melted spray material as a layer on the substrate, wherein the substrate is an aluminium alloy;
wherein the spray material includes alloy components of:
carbon: 0.1% by weight to 0.3% by weight of a total weight;
manganese: 1.5% by weight to 2.0% by weight of the total weight; and
silicon: 0.25% by weight to 0.4% by weight of the total weight;
mechanically roughening a surface of the substrate before the coating such that a roughness is formed with undercuts which are filled with the melted spray material over a course of the coating and which cause a mechanical interlocking of the melted spray material with the substrate; and
smoothing the coated surface.

8. The method according to claim 7, wherein the substrate has a thickness ranging from 2 mm to 8 mm at least in sections, perpendicularly to a main application direction of the coating.

9. A coated substrate, comprising:
an electric arc wire sprayed layer based on iron on a substrate, wherein the substrate is an aluminium alloy;
wherein the sprayed layer includes alloy components of:
carbon: 0.1% by weight to 0.3% by weight of a total weight;
manganese: 1.5% by weight to 2.0% by weight of the total weight; and
silicon: 0.25% by weight to 0.4% by weight of the total weight;
wherein a surface of the substrate has a roughness with undercuts which are filled with the sprayed layer and which cause a mechanical interlocking of the sprayed layer with the substrate.

10. The coated substrate according to claim 9, wherein the substrate has a thickness ranging from 2 mm to 8 mm at least in sections, perpendicularly to a main application direction of the sprayed layer.

11. The coated substrate according to claim 9, wherein the substrate is a running track of a cylinder crankcase.

12. The coated substrate according to claim 11, wherein the sprayed layer is arranged as an active partner to a steel piston in the cylinder crankcase.
